(19) United States
(12) Patent Application Publication
(10) Pub. No.: US 2023/0173313 A1
(43) Pub. Date: Jun. 8, 2023

(54) Lanyard Device for Monitoring Safety of a User

(71) Applicant: ZEBRA TECHNOLOGIES CORPORATION, Lincolnshire, IL (US)

(72) Inventors: Charles Burton Swope, Coral Springs, FL (US); Matthew B. Hayes, Wheaton, IL (US); Kester G. Matthew, Springfield Gardens, NY (US)

(21) Appl. No.: 17/543,861

(22) Filed: Dec. 7, 2021

(51) Int. Cl. A62B 35/00; G08B 21/02

(52) U.S. Cl. CPC A62B 35/0075; G08B 21/02

(57) ABSTRACT

In some implementations, a monitoring device associated with a lanyard device may detect that a portion of a strap of the lanyard device has extended from a strap core of the lanyard device. The monitoring device may generate a notification that the portion of the strap has extended from the strap core, wherein the lanyard device is configured to anchor the user to a support structure via the strap, and wherein a sensor within the monitoring device is configured to monitor a position of the strap relative to the strap core. The monitoring device may transmit, to a management device, the notification that the portion of the strap has extended from the strap core, wherein the notification includes an identifier associated with the lanyard device to alert the management device of a hazardous event involving the user.

### BACKGROUND

A lifeline can be used to improve the safety of users (e.g., individuals performing activities at relatively elevated heights). For example, the lifeline may include a lanyard that is anchored to the user and/or a support structure to prevent the user from falling from a height of the support structure. Accordingly, there is a need for a device or a system to detect that the user has fallen.

### SUMMARY

Some implementations described herein relate to a method for monitoring safety of a user. The method may include detecting, via a monitoring device associated with a lanyard device, that a portion of a strap of the lanyard device has extended from a strap core of the lanyard device. The method may include generating, via the monitoring device, a notification that the portion of the strap has extended from the strap core, where the lanyard device is configured to anchor the user to a support structure via the strap, and where a sensor within the monitoring device is configured to monitor a position of the strap relative to the strap core. The method may include transmitting, by the monitoring device and to a management device, the notification that the portion of the strap has extended from the strap core, where the notification includes an identifier associated with the lanyard device to alert the management device of a hazardous event involving the user.

Some implementations described herein relate to a device. The device may include one or more memories and one or more processors coupled to the one or more memories. The device may be configured to detect, via an indication from a sensor, that a portion of a strap of a lanyard device extended from a strap core of the lanyard device. The device may be configured to transmit, to a management device and based on detecting that the portion of the strap extended from the strap core, a notification that indicates a safety status associated with a user of the lanyard device.

Some implementations described herein relate to a lanyard device. The lanyard device may include a strap that includes a folded section, a strap core configured to store the folded section, a sensor, a communication component, and a controller. The controller may be configured to monitor the sensor to determine a status of the folded section. The controller may be configured to transmit, via the communication component and to a management device, a notification that indicates the status of the folded section.

### BRIEF DESCRIPTION OF THE DRAWINGS

FIG. 1 is a diagram of an example implementation associated with a lanyard device for monitoring safety of a user, as described herein.

FIG. 2 is a diagram of an example implementation described herein.

FIG. 3 is a diagram of an example call flow associated with a lanyard device described herein.

FIG. 4 is a diagram of an example environment in which systems and/or methods described herein may be implemented.

FIG. 5 is a diagram of example components of one or more devices of FIG. 4.

FIG. 6 is a flowchart of an example processes associated with a lanyard device monitoring safety of a user, as described herein.

### DETAILED DESCRIPTION

The following detailed description of example implementations refers to the accompanying drawings. The same reference numbers in different drawings may identify the same or similar elements.

A lifeline can improve safety and reduce risk to a user that is working at relatively elevated heights. The lifeline can include a lanyard with a strap that is arranged in a manner that can reduce an impact on the user when the user falls. For example, a section of the strap may be included, stored, and/or housed with a strap core of the lifeline. More specifically, the section can be folded or otherwise packed into the strap core such that when a user falls, the section unravels from within the strap core as portions of the section extend from the strap core. Despite this arrangement, in some cases, a user may be incapacitated before and/or during a fall (e.g., due to a health condition of the user) and/or may become incapacitated a result of a fall (e.g., due to an impact with a support structure or other object). In such a case, after a fall, the user may remain suspended from the lifeline until the user is no longer incapacitated and can return to safety or until the user found by another party and/or is rescued. Such a case may be worsened if the individual is relatively remotely located and/or performing the activity alone.

Accordingly, to further improve safety, there is a need for a system that is capable of monitoring the safety of the user and/or detecting a fall, and/or automatically alerting another individual, a device, and/or a system that a fall occurred. While certain devices, such as smartphones or other devices, may employ sensors for continuously monitoring a user (e.g., an accelerometer or other type of sensor) such devices and/or sensors typically require a continuous supply of a relatively high amount of power and/or a continuous dedicated communication link that continuously consumes computing resources (e.g., memory and/or processor resources) and/or communication resources while monitoring the user.

Some implementations described herein provide a lanyard device that is capable of detecting and/or indicating that a user of a lifeline was involved in a fall or other type of hazardous event. For example, the lanyard device may include a monitoring device that is arranged in association with a lifeline and/or arranged with a strap to form a lifeline. The lanyard device (and/or monitoring device) may include a sensor that is configured to monitor whether a portion of a strap has extended from a strap core of the lifeline, which is indicative of a hazardous event involving a user (e.g., the user falling or other type of movement that can be hazardous to the user). The lanyard device may be configured to communicate (e.g., via an antenna or other communication component of the monitoring device) with another device (e.g., a management device) that is configured to monitor and/or alert individuals, systems, or entities that a user associated with the lifeline has experienced a fall or other type of hazardous event. For example, a management device may be configured to communicate with and/or receive notifications from a plurality of lanyard devices to enable a user of the management device to remotely monitor a plurality of users associated with the lanyard devices.

In this way, the lanyard device can improve safety and/or use of a lifeline, thereby reducing risk to users of the lifeline. Furthermore, the lanyard device, as described herein, may conserve computing resources and/or power resources relative to other management devices and/or systems. For example, as described herein, the lanyard device may not require a continuous dedicated communication link with a management device, thereby conserving communication resources that would otherwise be consumed by utilizing the continuous dedicated communication link. Moreover, as described herein, the lanyard device may conserve power, relative to other monitoring systems, by utilizing a low-power sensor and/or a low-power, long range communication protocol. Additionally, or alternatively, a monitoring device of the lanyard device may be powered off until the monitoring device, via a passive sensor (e.g., a sensor with a non-powered component, such as a metallic element, that completes a circuit to activate the monitoring device), detects or indicates a user falling or experiencing another type of hazard.

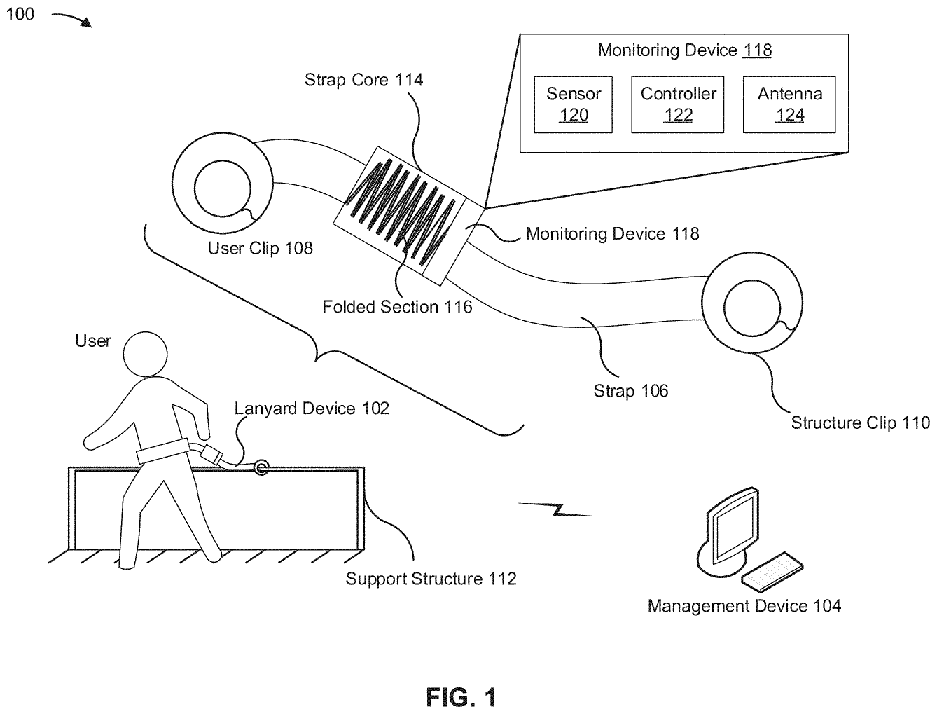

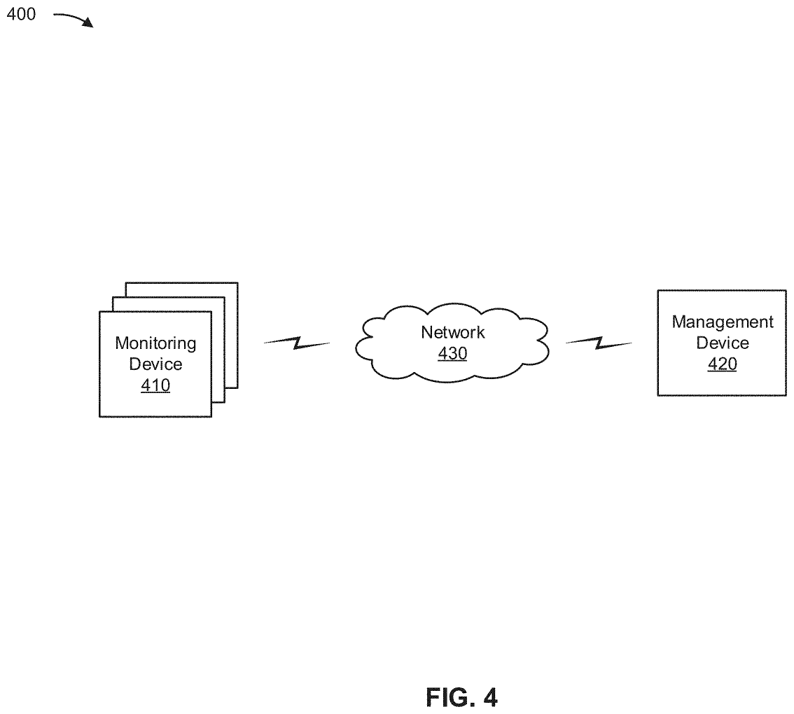

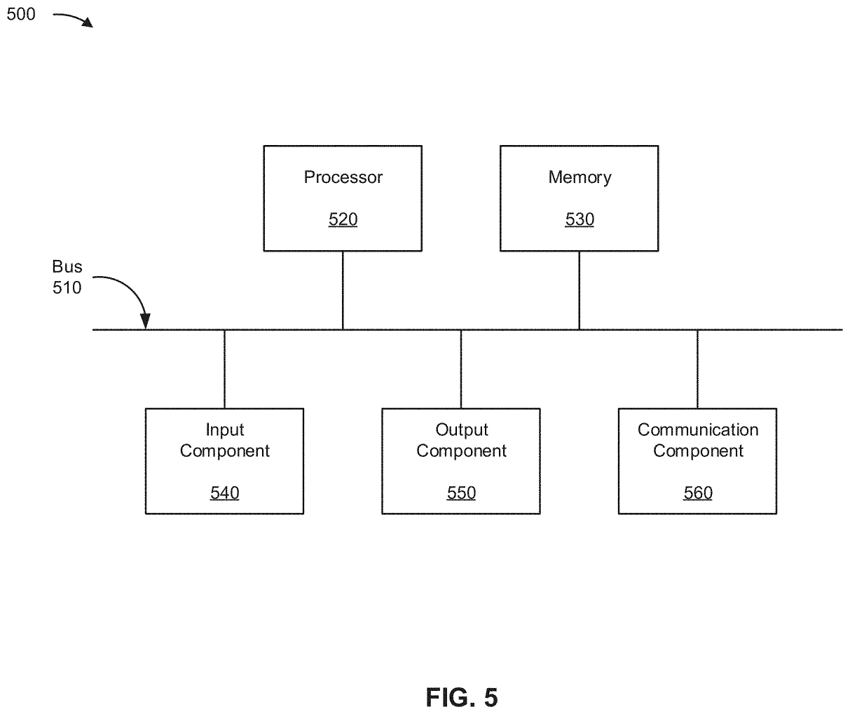

FIG. 1 is a diagram of an example implementation 100 associated with a lanyard device for monitoring safety of a user, as described herein. As shown in FIG. 1, example implementation 100 includes a lanyard device 102 and a management device 104. These devices are described in more detail below in connection with FIG. 4 and FIG. 5.

Similar to a lifeline (or other similar type of personal protective equipment (PPE)), the lanyard device 102, as described herein, may include a strap 106, a user clip 108 that is configured to attach to the user (e.g., to a belt or harness worn by the user), a structure clip 110 that is configured to attach to a support structure 112 (e.g., a railing, an anchor, or other secure mechanism near the user), and a strap core 114. The strap core 114, as shown, includes a folded section 116 of the strap 106 that is configured to extended from the strap core 114 in the event that a threshold degree of tension or force is applied on the strap 106 between the user clip 108 and the structure clip 110. The strap 106 may be a single solid strap between the user clip 108 and the structure clip 110 and/or multiple separate straps that are attached to one another. The strap core 114 may be configured and/or attached to the strap 106 (or multiple straps) in any suitable manner to form and/or serve as a lifeline, as described herein.

As shown in FIG. 1, the lanyard device 102 includes a monitoring device 118. The monitoring device 118 may include a sensor 120, a controller 122, and an antenna 124. As described herein, the monitoring device 118 may be configured to monitor, via the sensor 120, the strap 106 (e.g., the folded section 116 of the strap 106) and/or the strap core 114 to determine a status of the lanyard device 102. For example, the controller 122 may receive, from the sensor 120, an indication of whether a portion of the strap 106 has extended from the strap core 114. Similar to a lifeline, a portion of the folded section 116 may be configured to extend from the strap core 114 in association with the user experiencing a hazardous event, such as a fall or other type of movement that is indicative of a threshold amount of force and/or a threshold increase in distance that separates the user clip 108 from the structure clip 110 and/or the user from the support structure 112.

The sensor 120 may be an optical sensor, a magnetic sensor, a pressure sensor, and/or a resistance sensor that is configured to monitor a position of the strap 106 and/or a condition of the strap core 114. The sensor 120 may determine a position of the strap 106 and/or a condition of the strap core 114 to identify whether a portion of the folded section 116 within the strap core 114 has extended from the strap core 114. For example, an optical sensor may be configured to sense when a marking on the strap 106 (e.g., a portion of the folded section 116) passes within or through a field of view of the optical sensor. A magnetic sensor may be configured to sense when a metallic element (e.g., a magnetic piece of metal within or attached to the strap 106) passes through a magnetic field associated with the magnetic sensor (or vice versa). A pressure sensor may be configured to sense a pressure within a component or element of a system (e.g., within a strap core 114 and/or within the strap 106). A resistance sensor may be configured to sense when a metallic element (e.g., a conductive piece of metal within or attached to the strap 106) makes contact with or completes a circuit associated with the resistance sensor (e.g., a circuit of the monitoring device 118).

In some implementations, the sensor 120 is configured to monitor a condition of the strap core 114 and generate an indication that a portion of the strap 106 has extended from the strap core 114 based on detecting a change in the condition. For example, the sensor 120 may include a breakaway sensor that is configured to monitor the strap core 114. The breakaway sensor may determine whether housing elements (e.g., a housing element associated with the folded section 116 and a housing element associated with the monitoring device 118 that encloses the folded section 116 within the strap core 114, or any other separate housing elements of the strap core 114) of the strap core 114 are intact or separated. For example, the housing elements may be configured to separate when a threshold amount of separable force is applied on the strap core 114 (e.g., an amount of force that is indicative of the user experiencing a fall or other type of hazardous event). More specifically, the breakaway sensor may include an optical sensor that senses light within the strap core 114 and/or a resistance sensor that senses contact between the housing elements or analyzes circuitry through the housing elements. In this way, the breakaway sensor may be configured to generate an indication that the portion of the strap 106 has extended from the strap core 114 based on a change in a state of the strap core 114.

In some implementations, the sensor 120 may include a tension sensor that is configured to monitor tension within the strap 106 or a portion of the strap 106. The tension sensor may be configured, in any suitable manner (using an optical sensor, a magnetic sensor, a pressure sensor, and/or a resistance sensor, among other examples), to sense and/or measure tension along one or more sections of the strap 106 and/or at one or more points of connection between components or elements of the lanyard device 102 (e.g., between the strap core 114 and a section of the strap 106). The tension sensor may indicate that a portion of the strap 106 has extended from the strap core 114 based on detecting that the tension satisfies a threshold (e.g., a threshold that is indicative of the user experiencing a fall or other type of hazardous event).

The antenna 124 may include or be associated with a communication component that enables wireless communication between the lanyard device 102 and another device (e.g., the management device 104). The antenna 124 may be configured to utilize one or more communication protocols to permit the lanyard device 102 to communicate with the management device 104 and/or transmit a notification to the management device 104. For example, the antenna 124 may be configured for long-range, wide local area network communication and/or low-power communication via a wide area network. Similarly, the management device 104 may be configured to communicate with the lanyard device 102 and/or receive notifications from the lanyard device 102 using corresponding ones of the communication protocols.

In some implementations, the lanyard device 102 may be registered with the management device 104. For example, the lanyard device 102 may perform a registration process to register the lanyard device 102 to the user and to facilitate communication with the management device 104. The lanyard device 102 may register an identifier (e.g., an identifier associated with the user and/or an identifier associated with the lanyard device 102) with the management device 104 in order to permit the management device 104 (or a user of the management device 104) to identify and/or determine that the lanyard device 102 is in active use by the user.

In some implementations, the management device 104, based on the identifier and/or using any suitable data structure or backend system, may use the identifier to determine a location of the user and/or the lanyard device 102 in association with the registration process. In this way, in the event that the lanyard device 102 communicates with the management device 104 (e.g., provides a notification of a fall or other type of hazardous event), the management device 104 can determine the location of the lanyard device 102 (e.g., in order to assist with rescuing the user).

In some implementations, the lanyard device 102 may include a user interface that enables the user to provide an input to the lanyard device 102. For example, the user interface may include one or more input elements that enable a user to provide an input (e.g., to activate the lanyard device 102 and/or to communicate with the management device 104, as described elsewhere herein). Additionally, or alternatively, the user interface may include one or more output elements that enable the user to receive an output (e.g., an audio output that indicates a status of a communication with the management device 104).

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

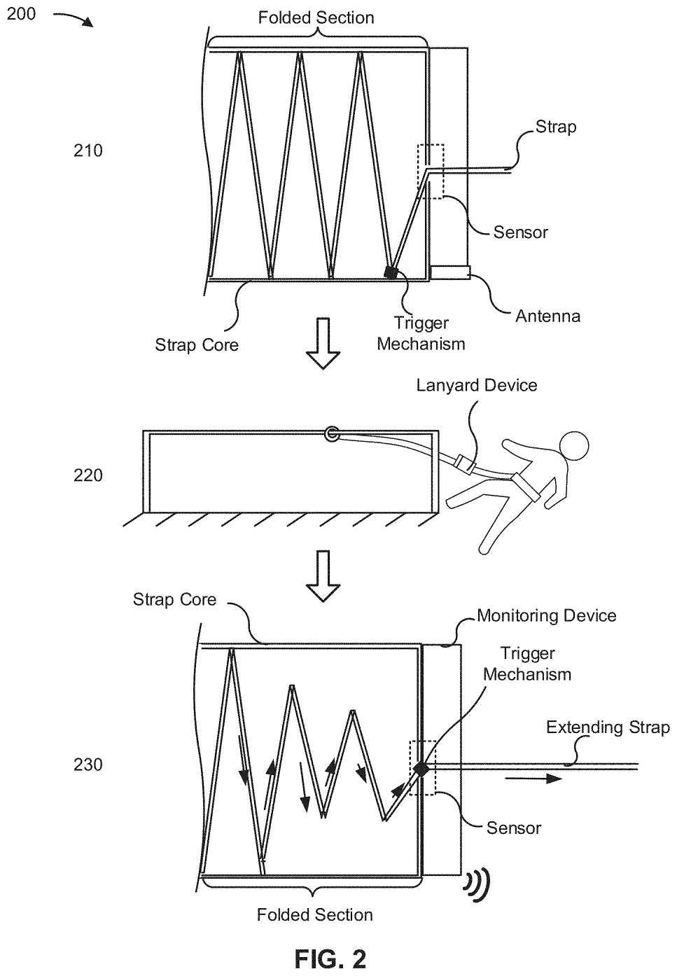

FIG. 2 is a diagram of an example implementation 200 associated with using a lanyard device (e.g., the lanyard device 102). As shown in FIG. 2, a lanyard device is used to detect a user experiencing a hazardous event (e.g., a fall from a support structure) and transmit (or broadcast) a notification.

As shown by reference number 210, a folded section of a strap of the lanyard device is within a strap core. A trigger mechanism is included on a particular portion of the folded section. The trigger mechanism may include a marking and/or a metallic element that is attached and/or within the strap (e.g., interwoven within fibers of the strap). The trigger mechanism may be configured on the strap (e.g., prior to use of the lanyard device, during manufacturing, and/or the like) to indicate an occurrence of an event, such as a hazardous event such as a fall described herein, or a less severe event, such as the user causing only a subsection of the folded section to extend from the strap core by extending from or reaching far from a support structure.

As shown by reference number 220, the user may fall from the support structure. Accordingly, as shown by reference number 230, a portion of the folded section may extend from the strap core, causing the trigger mechanism to advance toward the sensor and/or into a detectable range of the sensor (e.g., due to physical separation of the user from the support structure and the strap being anchored to the support mechanism and the user). The detectable range may include a field of view of an optical sensor, a magnetic field of a magnetic sensor, and/or a contact position of a resistance sensor.

In example implementation 200, a sensor (e.g., the sensor 120) may be attached to an edge of the strap core. Accordingly, when the portion of the folded section that includes the trigger mechanism reaches the edge of (and/or extends from) the strap core, the sensor may detect the trigger mechanism. Correspondingly, the controller 122 of the lanyard device may receive, from the sensor sensing the trigger mechanism, an indication that a portion of the strap (e.g., a portion of the folded section) has extended from the strap core. In this way, based on the trigger mechanism being detected by the sensor, the lanyard device may detect that a portion of the strap has extended from the strap core.

Correspondingly, based on detecting the trigger mechanism, the lanyard device may transmit (e.g., to the management device 104) and/or broadcast (e.g., similar to a beacon) a notification that indicates that the user has fallen, that the lanyard device has detected a hazardous event, and/or that identifies the user and/or the lanyard device (e.g., via an identifier), among other examples. In this way, the lanyard device may provide and/or cause another device (e.g., the management device 104) to provide an alert associated with a hazardous event involving the user.

In some implementations, the strap may be configured to include multiple trigger mechanisms. For example, the multiple trigger mechanisms may be positioned at various locations along the strap. Accordingly, different trigger mechanisms may correspond to different types of movement and/or severities of events. For example, a trigger mechanism that is positioned along the strap to be relatively near the sensor would indicate, if sensed by a sensor, a less drastic type of movement (or less severe type of event) than a sensor that is positioned along the strap further from the sensor. Additionally, or alternatively, the sensor may track and/or indicate a number of trigger mechanisms that were sensed in association with an event (e.g., within a certain time period associated with the event). In such a case, the more trigger mechanisms that are sensed, the more drastic the type of movement and/or severe the type of event.

As indicated above, FIG. 2 is provided as an example. Other examples may differ from what is described with regard to FIG. 2.

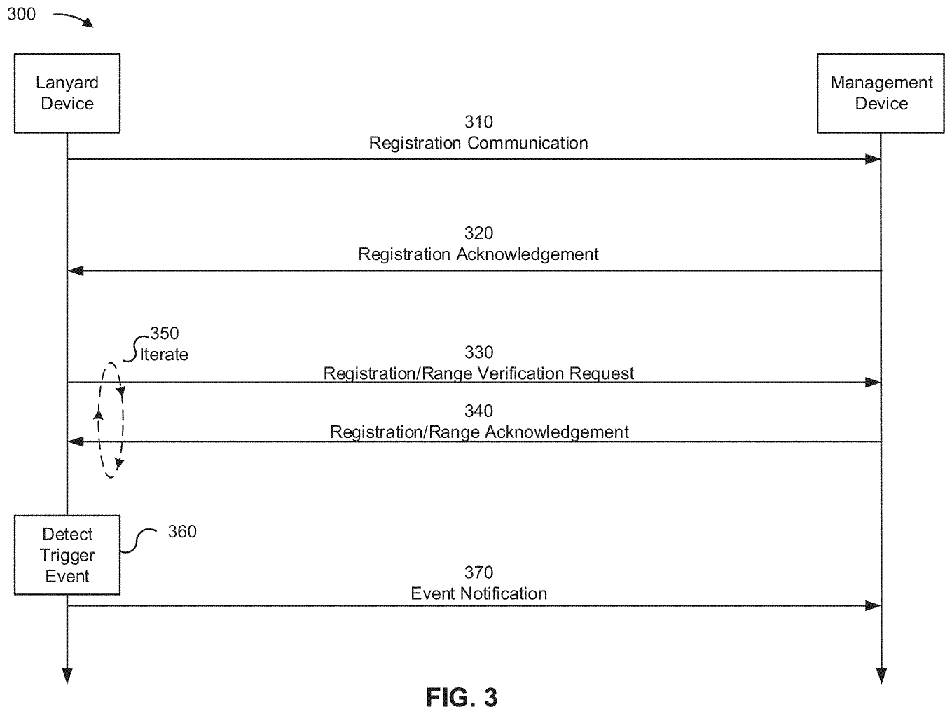

FIG. 3 is a diagram illustrating an example call flow 300 associated with a lanyard device described herein. As shown in FIG. 3, a lanyard device and a management device may communicate with one another. For example, the lanyard device and the management device may communicate via a network, such as a long range wireless local area network or a low-power wide area network.

As shown by reference number 310, the lanyard device may send a registration communication to the management device. For example, the registration communication may indicate an identifier of a user and/or an identifier of the lanyard device to indicate that the lanyard device is in active use.

As shown by reference number 320, the management device may send a registration acknowledgement to the lanyard device (e.g., an ACK response). The management device may acknowledge the registration communication to enable the lanyard device to verify or determine that the lanyard device is within communication range of the management device. In some implementations, the management device may send the registration acknowledgement based on registering the lanyard device as in active use, identifying a location of the lanyard device (e.g., based on the identifier being associated with the location), or the like.

As shown by reference number 330, the lanyard device may send a registration/range verification request to the management device. For example, periodically, the lanyard device may verify that the registration is active and/or that the lanyard device is within communication range of the management device (e.g., similar to a health ping that ensures that the lanyard device can effectively communicate with the management device, if necessary).

As shown by reference number 340, the management device may send a registration range acknowledgement (e.g., another ACK response). In this way, the lanyard device may verify that the registration of the lanyard device is active and/or that the lanyard device is within communication range of the management device. As shown by reference number 350, the lanyard device and management device may iteratively (e.g., periodically, according to a schedule, and/or based on a user input to the lanyard device) communicate registration/range requests and/or acknowledgements to ensure that the lanyard device can effectively be used to monitor a user of the lanyard device and communicate with the management device.

As shown by reference number 360, the lanyard device may detect a trigger event. For example, the lanyard device may determine that a fall or other type of hazardous event associated with a user has occurred. The lanyard device may determine that the fall or other type of hazardous event occurred based on detecting that a portion of a strap has extended from a strap core, as described herein.

As shown by reference number 370, the lanyard device may transmit an event notification to the management device. For example, the lanyard device may indicate, within the notification, the identifier associated with the user and/or the lanyard device and/or a type of event that was detected. The type of event may be determined or indicated based on an indication from the sensor (e.g., an indication of which trigger mechanism was sensed and/or a quantity of trigger mechanisms along the folded section of the strap were sensed or determined to extend from the strap core).

As indicated above, FIG. 3 is provided as an example. Other examples may differ from what is described with respect to FIG. 3.

FIG. 4 is a diagram of an example environment 400 in which systems and/or methods described herein may be implemented. As shown in FIG. 4, environment 400 may include one or more monitoring devices 410, a management device 420, and a network 430. Devices of environment 400 may interconnect via wired connections, wireless connections, or a combination of wired and wireless connections.

The monitoring device 410 includes one or more devices capable of receiving, generating, storing, processing, and/or providing information associated with monitoring safety of a user utilizing a lanyard device (e.g., a lifeline), as described elsewhere herein. The monitoring device 410 may include a communication device and/or a computing device (e.g., a controller) that is associated with a lanyard and/or a lanyard device. For example, the monitoring device 410 may include and/or be associated with a lifeline (or other similar equipment) that includes a sensor and a wireless communication device, as described herein. The monitoring device 410 may correspond to the monitoring device 118 of example implementation 100.

The management device 420 includes one or more devices capable of receiving, generating, storing, processing, and/or providing information associated with one or more notifications from one or more of the monitoring devices 410, as described elsewhere herein. The management device 420 may include a communication device and/or a computing device. For example, the management device 420 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 430 includes one or more wired and/or wireless networks. For example, the network 430 may include a wireless wide area network (e.g., cellular network or a public land mobile network), a local area network (e.g., a wired local area network or a wireless local area network (WLAN), such as a long range (LoRa) wide-area local network, a low-power wide area network, or a Wi-Fi network), a personal area network (e.g., a Bluetooth network), a near-field communication network, a telephone network, a private network, the Internet, and/or a combination of these or other types of networks. The network 430 enables communication among the devices of environment 400.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500, which may correspond to the monitoring device 410 and/or the management device 420. In some implementations, the monitoring device 410 and/or the management device 420 may include one or more devices 500 and/or one or more components of device 500. As shown in FIG. 5, device 500 may include a bus 510, a processor 520, a memory 530, an input component 540, an output component 550, and a communication component 560.

Bus 510 includes one or more components that enable wired and/or wireless communication among the components of device 500. Bus 510 may couple together two or more components of FIG. 5, such as via operative coupling, communicative coupling, electronic coupling, and/or electric coupling. Processor 520 includes a central processing unit, a graphics processing unit, a microprocessor, a controller, a microcontroller, a digital signal processor, a field-programmable gate array, an application-specific integrated circuit, and/or another type of processing component. Processor 520 is implemented in hardware, firmware, or a combination of hardware and software. In some implementations, processor 520 includes one or more processors capable of being programmed to perform one or more operations or processes described elsewhere herein.

Memory 530 includes volatile and/or nonvolatile memory. For example, memory 530 may include random access memory (RAM), read only memory (ROM), a hard disk drive, and/or another type of memory (e.g., a flash memory, a magnetic memory, and/or an optical memory). Memory 530 may include internal memory (e.g., RAM, ROM, or a hard disk drive) and/or removable memory (e.g., removable via a universal serial bus connection). Memory 530 may be a non-transitory computer-readable medium. Memory 530 stores information, instructions, and/or software (e.g., one or more software applications) related to the operation of device 500. In some implementations, memory 530 includes one or more memories that are coupled to one or more processors (e.g., processor 520), such as via bus 510.

Input component 540 enables device 500 to receive input, such as user input and/or sensed input. For example, input component 540 may include a touch screen, a keyboard, a keypad, a mouse, a button, a microphone, a switch, a sensor, a global positioning system sensor, an accelerometer, a gyroscope, and/or an actuator. Output component 550 enables device 500 to provide output, such as via a display, a speaker, and/or a light-emitting diode. Communication component 560 enables device 500 to communicate with other devices via a wired connection and/or a wireless connection. For example, communication component 560 may include a receiver, a transmitter, a transceiver, a modem, a network interface card, and/or an antenna.

Device 500 may perform one or more operations or processes described herein. For example, a non-transitory computer-readable medium (e.g., memory 530) may store a set of instructions (e.g., one or more instructions or code) for execution by processor 520. Processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry is used instead of or in combination with the instructions to perform one or more operations or processes described herein. Additionally, or alternatively, processor 520 may be configured to perform one or more operations or processes described herein. Thus, implementations described herein are not limited to any specific combination of hardware circuitry and software.

The number and arrangement of components shown in FIG. 5 are provided as an example. Device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

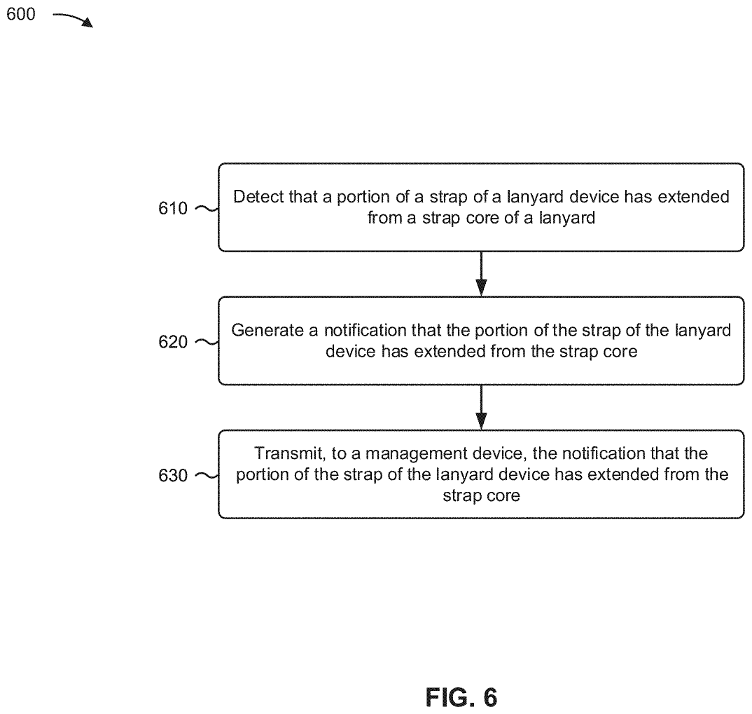

FIG. 6 is a flowchart of an example process 600 associated with a lanyard device for monitoring safety of a user. In some implementations, one or more process blocks of FIG. 6 may be performed by a monitoring device (e.g., monitoring device 410) associated with a lanyard device. In some implementations, one or more process blocks of FIG. 6 may be performed by another device or a group of devices separate from or including the monitoring device, such as a management device (e.g., the management device 420). Additionally, or alternatively, one or more process blocks of FIG. 6 may be performed by one or more components of device 500, such as processor 520, memory 530, input component 540, output component 550, and/or communication component 560.

As shown in FIG. 6, process 600 may include detecting that a portion of a strap of the lanyard device has extended from a strap core of the lanyard device (block 610). For example, a monitoring device of a lanyard device may detect that a portion of a strap of the lanyard device has extended from a strap core of the lanyard device, as described above.

In some implementations, the monitoring device may register (e.g., prior to detecting the portion of the strap of the lanyard device has extended from the strap core) an identifier associated with a management device, as described above. For example, the identifier may be registered with the management device via a long range, wide area local network.

As further shown in FIG. 6, process 600 may include generating a notification that the portion of the strap has extended from the strap core (block 620). For example, the monitoring device may generate (e.g., based on sensor data from a sensor of the monitoring device) the notification that the portion of the strap has extended from the strap core, as described above. In some implementations, the lanyard device is configured to anchor the user to a support structure via the strap. A sensor within the monitoring device may be configured to monitor a position of the strap relative to the strap core. Accordingly, the monitoring device may generate the notification based on sensor data from the sensor indicating that position of the strap relative to the strap core has moved, thereby indicating that the strap of the lanyard device has extended from the strap core.

The portion of the strap may be identified by a marking, and the sensor may be configured to monitor the position of the strap based on the marking. A controller of the monitoring device may be configured to generate the indication based on the sensor identifying the marking as the portion of the strap of the lanyard device extends from the strap core. Prior to the portion of the strap extending from the strap core, the marking may be positioned on the portion of the strap within the strap core of the lanyard device to indicate that the user was involved in a certain type of movement that caused the sensor to identify the marking. The position of the marking on the strap may correspond to a severity movement that indicates the type of movement (e.g., a fall, the user extending on the lanyard device by pulling away from a support structure, or the like). In some implementations, the notification may identify the certain type of movement.

In some implementations, the sensor may monitor a condition of the strap core, and a controller of the monitoring device may generate the notification based on the sensor detecting a change to the condition of the strap core. The sensor may include a breakaway sensor that monitors the strap core. A controller of the monitoring device may generate the notification based on the breakaway sensor detecting that the strap core has changed to a state that indicates that the portion of the strap has extended from the strap core. Additionally, or alternatively, the sensor may include a tension sensor that is configured to measure tension in the strap, and the controller of the monitoring device may generate the notification based on the tension sensor sensing that tension in the strap satisfies a threshold.

As further shown in FIG. 6, process 600 may include transmitting, to a management device, the notification that the portion of the strap has extended from the strap core, wherein the notification includes an identifier associated with the lanyard device to alert the management device of a hazardous event involving the user (block 630). For example, the monitoring device may transmit, to a management device, the notification that the portion of the strap has extended from the strap core, wherein the notification includes an identifier associated with the lanyard device to alert the management device of a hazardous event involving the user, as described above. In some implementations, the notification includes an identifier associated with the lanyard device to alert the management device of a hazardous event involving the user.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software. As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, or the like) on which machine-readable instructions (e.g., code in the form of, for example, software and/or firmware) can be stored. The instructions may be stored for any suitable duration of time, such as permanently, for an extended period of time (e.g., while a program associated with the instructions is executing), or for a short period of time (e.g., while the instructions are cached, during a buffering process, or the like). Further, as used herein, each of the terms “tangible machine-readable medium,” “non-transitory machine-readable medium” and “machine-readable storage device” is expressly defined to exclude propagating signals. That is, as used in any claim herein, a “tangible machine-readable medium,” a “non-transitory machine-readable medium,” and a “machine-readable storage device,” or the like, should not be interpreted as being implemented as a propagating signal.

As used herein, satisfying a threshold may, depending on the context, refer to a value being greater than the threshold, greater than or equal to the threshold, less than the threshold, less than or equal to the threshold, equal to the threshold, not equal to the threshold, or the like.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method for monitoring safety of a user, the method comprising:
detecting, via a monitoring device associated with a lanyard device, that at least a portion of a folded section of a strap of the lanyard device has extended from a strap core of the lanyard device;
generating, via the monitoring device, a notification that the at least portion of the folded section of the strap has extended from the strap core,
wherein the lanyard device is configured to anchor the user to a support structure via the strap, and
wherein a sensor within the monitoring device is configured to monitor a position of the strap relative to the strap core; and
transmitting, by the monitoring device and to a management device, the notification that the at least portion of the folded section of the strap has extended from the strap core,
wherein the notification includes an identifier associated with the lanyard device to alert the management device of a hazardous a type of event involving the user.

2. The method of claim 1, wherein the identifier is registered with the management device via a long range, wide area local network.

3. The method of claim 1, wherein the at least portion of the folded section of the strap is identified by a marking,
wherein the sensor is configured to monitor the position of the strap based on the marking, and
wherein a controller of the monitoring device is configured to generate the notification based on the sensor identifying the marking as the at least portion of the folded section of the strap of the lanyard device extends from the strap core.

4. The method of claim 3, wherein, prior to the at least portion of the folded section of the strap extending from the strap core, the marking is configured to be positioned on the at least portion of the folded section of the strap within the strap core to indicate a severity of an event indicative of the type of event that the user was involved in that caused the sensor to identify the marking,
wherein the notification identifies the type of event.

5. The method of claim 1, wherein the sensor is configured to monitor a condition of the strap core, and
wherein a controller of the monitoring device is configured to generate the notification based on the sensor detecting a change to the condition of the strap core.

6. The method of claim 1, wherein the sensor comprises a breakaway sensor that is configured to monitor the strap core, and
wherein a controller of the monitoring device is configured to generate the notification based on the breakaway sensor detecting that the strap core has changed to a state that indicates that the at least portion of the folded section of the strap has extended from the strap core.

7. The method of claim 1, wherein the sensor comprises a tension sensor that is configured to measure tension in the folded section of the strap,
wherein a controller of the monitoring device is configured to generate the notification based on the tension sensor sensing that tension in the folded section of the strap satisfies a threshold.

8. A device, comprising:
one or more memories; and
one or more processors, coupled to the one or more memories, configured to:
detect, via an indication from a sensor, that at least a portion of a folded section of a strap of a lanyard device extended from a strap core of the lanyard device,
wherein the sensor is configured to monitor a position of the strap relative to the strap core; and
transmit, to a management device and based on detecting that the at least portion of the folded section of the strap extended from the strap core, a notification that indicates a safety status associated with a user of the lanyard device.

9. The device of claim 8, wherein the at least portion of the folded section of the strap includes a metallic element,
wherein the sensor is configured to monitor the position of the folded section of the strap based on the metallic element, and
wherein the sensor is configured to generate the indication based on the metallic element contacting the sensor as the at least portion of the folded section of the strap is extended from the strap core.

10. The device of claim 9, wherein, prior to the at least portion of the folded section of the strap extending from the strap core, the metallic element is configured to be positioned on the at least portion of the folded section of the strap within the strap core to indicate a severity of a movement indicative of a type of movement that the user was involved in that caused the sensor to sense the metallic element,
wherein the notification identifies the type of movement.

11. The device of claim 8, wherein the safety status indicates that the user experienced a type of movement that satisfied a threshold associated with the at least portion of the folded section of the strap extending from the strap core.

12. The device of claim 8, wherein the sensor comprises at least one of:
an optical sensor,
a magnetic sensor, or
a resistance sensor.

13. The device of claim 8, wherein the device is registered with the management device in association with an identifier that is associated with the device and/or the user.

14. The device of claim 8, wherein the management device is communicatively coupled to a long range, wide area local network, and
wherein the notification is transmitted to the management device via the long range, wide area local network.

15. A lanyard device, comprising:
a strap that includes a folded section;
a strap core configured to store the folded section;
a sensor;
a communication component; and
a controller that is configured to:
monitor the sensor to determine a status of the folded section,
wherein the status is indicative of whether a particular portion of the folded section is within the strap core, and whether a user of the device experienced a type of movement that satisfied a threshold associated with the particular portion of the folded section of the strap extending from the strap core; and
transmit, via the communication component and to a management device, a notification that indicates the status of the folded section.

16. The lanyard device of claim 15, wherein the sensor is configured to monitor a position of the folded section based on a marking associated with the folded section, and
wherein the sensor is configured to generate the indication based on detecting the marking within a detectable range of the sensor.

17. The lanyard device of claim 15, wherein the controller is further configured to:
determine, based on an indication from the sensor, that the particular portion of the folded section extended from the strap core,
wherein the notification is transmitted based on determining that the particular portion of the folded section extended from the strap core.

18. The lanyard device of claim 15, wherein the controller is further configured to:
verify a registration with the management device according to a communication protocol of a long range, wide area local network.

19. The lanyard device of claim 15, wherein the sensor comprises at least one of:
an optical sensor,
a magnetic sensor, or
a resistance sensor.

20. The lanyard device of claim 15, wherein the notification is transmitted to the management device via a long range, wide area local network.
